(19) United States
(12) Patent Application Publication
(10) Pub. No.: US 2017/0076027 A1
(43) Pub. Date: Mar. 16, 2017

(54) INFORMATION PROCESSING DEVICE, INFORMATION PROCESSING METHOD, AND STORAGE MEDIUM WHEREIN INFORMATION PROCESSING PROGRAM IS STORED

(71) Applicant: NEC CORPORATION, Tokyo (JP)

(72) Inventors: Mizuki IWANAMI, Tokyo (JP); Kenta TSUKAMOTO, Tokyo (JP); Taras KUSHTA, Tokyo (JP)

(73) Assignee: NEC CORPORATION, Tokyo (JP)

(21) Appl. No.: 15/122,706

(22) PCT Filed: Jan. 20, 2015
(86) PCT No.: PCT/JP2015/000224

§ 371 Date: Aug. 31, 2016

(30) Foreign Application Priority Data
Mar. 3, 2014 (JP) 2014-040294

(51) Int. Cl. G06F 17/50

(52) U.S. Cl. CPC G06F 17/5036; G06F 17/5081

(57) ABSTRACT

[Problem] To design a circuit configuration whereby communication performance degradation from noise coupling is pre-suppressed. [Solution] An information processing device comprising: a noise estimation means for estimating, on the basis of an wiring layout of an information processing circuit, radiation noise which would be radiated from the information processing circuit; a wiring information change means for changing circuit information determining the wiring layout of the information processing circuit; a radiation direction assessment means for assessing whether the radiation noise which would be radiated from the information processing circuit will be radiated in a direction having less of an effect on a communication circuit in proximity to the information processing circuit; and an appropriate circuit information output means for generating and outputting suitable circuit information such that radiation noise has less of an effect on the communication circuit, by repeating the noise estimation process from the noise estimation means and the assessment of the radiating direction assessment means according to the circuit information as changed by the wiring information change means.

### TECHNICAL FIELD

The present invention relates to an information processing device, an information processing method, and a storage medium storing an information processing program.

### BACKGROUND ART

As described in NPL 1, there exist a noise source model for use in estimating radiation noise radiated from an integrated circuit (IC), and an IC design support system using the noise source model. NPL 1 discloses modeling an IC with use of an electric dipole or a magnetic dipole, and calculating a radiation electromagnetic field radiated from the IC on the basis of the model.

### CITATION LIST

### [Non Patent Literature]

[NPL 1] IEC New Work Item Proposal, 47A/927/NP, IEC 62433-3: EMC IC modeling-Part 3: Models of Integrated Circuits for EMI behavioural simulation-Radiated emissions modeling (ICEM-RE) (http://standardsproposals.bsigroup.com/Home/Proposal/2911)

### SUMMARY OF INVENTION

### Technical Problem

However, in NPL 1, there is no description about a detailed modeling method of circuit wirings and a design method, and there is no idea of applying the technique described in NPL 1 to an IC in which a digital circuit and a radio frequency (RF) circuit are mounted on one chip.

An object of the present invention is to provide a technique in which a calculation result of a radiation electromagnetic field is reflected for circuit designing.

### Solution to Problem

To achieve the above mentioned object, an information processing device, according to the present invention, comprises:

a noise estimation means which estimates radiation noise radiated from an information processing circuit on the basis of a wiring layout of the information processing circuit;

a wiring information changing means which changes circuit information for determining the wiring layout of the information processing circuit;

a radiation direction determination means which determines whether or not radiation noise radiated from the information processing circuit is radiated in a direction in which an influence on a communication circuit in proximity to the information processing circuit is small; and

an appropriate circuit information output means which generates and outputs appropriate circuit information indicating that an influence of radiation noise on the communication circuit is small by repeating the noise estimation process by the noise estimation means and the determination by the radiation direction determination means according to the circuit information changed by the wiring information changing means.

To achieve the above mentioned object, an information processing method, according to the present invention, comprises:

a noise estimating step for estimating radiation noise radiated from an information processing circuit on the basis of a wiring layout of the information processing circuit;

a circuit information changing step for changing circuit information for determining the wiring layout of the information processing circuit;

a radiation direction determining step for determining whether or not radiation noise radiated from the information processing circuit is radiated in a direction in which an influence on a communication circuit in proximity to the information processing circuit is small; and

an appropriate circuit information output step for generating and outputting appropriate circuit information indicating radiation of radiation noise in a direction in which an influence on the communication circuit in proximity to the information processing circuit is small by repeating the estimation of radiation noise by the noise estimating step and the determination according to the circuit information changed by the circuit information changing step.

To achieve the above mentioned object, a storage medium, according to the present invention, storing an information processing program which causes a computer to execute:

a noise estimating step for estimating radiation noise radiated from an information processing circuit on the basis of a wiring layout of the information processing circuit;

a circuit information changing step for changing circuit information for determining the wiring layout of the information processing circuit;

a radiation direction determining step for determining whether or not radiation noise radiated from the information processing circuit is radiated in a direction in which an influence on a communication circuit in proximity to the information processing circuit is small; and

an appropriate circuit information output step for generating and outputting appropriate circuit information indicating radiation of radiation noise in a direction in which an influence on the communication circuit in proximity to the information processing circuit is small by repeating the estimation of radiation noise by the noise estimating step and the determination according to the circuit information changed by the circuit information changing step.

### Advantageous Effects of Invention

According to the present invention, it is possible to design a circuit configuration, in which deterioration of communication performance by noise coupling is suppressed in advance.

### BRIEF DESCRIPTION OF DRAWINGS

FIG. 1 is a diagram illustrating a configuration of an information processing device as a first exemplary embodiment of the present invention.

FIG. 2 is a diagram illustrating an example of a circuit configuration to be handled by an information processing device as a second exemplary embodiment of the present invention.

FIG. 3 is a schematic diagram of power source/ground wirings from a power source to an IC chip in a circuit configuration to be handled by the information processing device as the second exemplary embodiment of the present invention, and an equivalent circuit diagram thereof.

FIG. 4 is an equivalent circuit diagram of an electric/magnetic dipole in a circuit configuration to be handled by the information processing device as the second exemplary embodiment of the present invention.

FIG. 5 is a block diagram illustrating a functional configuration of the information processing device as the second exemplary embodiment of the present invention.

FIG. 6 is a flowchart illustrating an operation of a structure model element extraction unit in the information processing device as the second exemplary embodiment of the present invention.

FIG. 7 is a flowchart illustrating an operation of a simple noise source model generation unit in the information processing device as the second exemplary embodiment of the present invention.

FIG. 8 is a flowchart illustrating an operation of a radiation noise estimation unit in the information processing device as the second exemplary embodiment of the present invention.

FIG. 9 is a flowchart illustrating an operation of a radiation direction determination unit in the information processing device as the second exemplary embodiment of the present invention.

FIG. 10 is an explanatory diagram including a schematic plan view of an IC chip on which a digital circuit and an RF circuit are mounted, and a radiation pattern schematic diagram analyzed by the radiation noise estimation unit in the information processing device.

FIG. 11 is an explanatory diagram including a schematic plan view of an IC chip on which a digital circuit and an RF circuit are mounted, and a radiation pattern schematic diagram, in which the length of power source/ground wirings is changed with respect to the wiring layout exemplified in FIG. 10.

FIG. 12 is a diagram illustrating an example of a table to be stored in a storage unit in the information processing device as the second exemplary embodiment of the present invention.

### DESCRIPTION OF EMBODIMENTS

In the following, exemplary embodiments of the present invention are exemplarily described in detail referring to the drawings. Note that constituent elements described in the following exemplary embodiments are merely an example, and do not limit the technical scope of the present invention.

### First Exemplary Embodiment

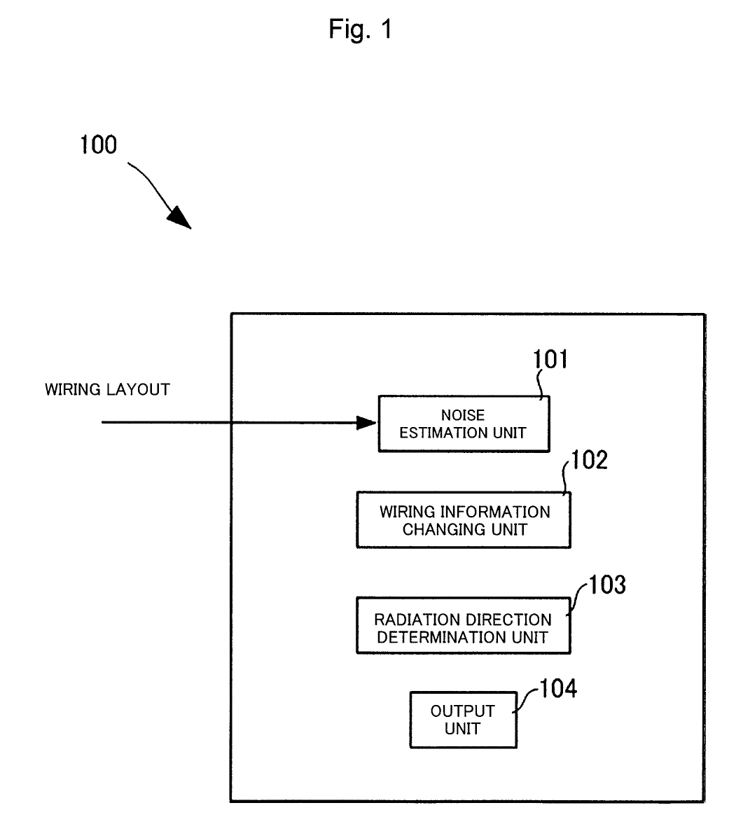

An information processing device 100 as the first exemplary embodiment of the present invention is described referring to FIG. 1. As illustrated in FIG. 1, the information processing device 100 includes a noise estimation unit 101, a wiring information changing unit 102, a radiation direction determination unit 103, and an output unit 104. The noise estimation unit 101 estimates radiation noise radiated from an information processing circuit on the basis of a wiring layout of the information processing circuit. The wiring information changing unit 102 changes circuit information for use in determining a wiring layout of the information processing circuit. The radiation direction determination unit 103 determines whether or not radiation noise radiated from the information processing circuit is radiated in a direction in which an influence on a communication circuit in proximity to the information processing circuit is small. By repeating the noise estimation process by the noise estimation unit 101, and the determination by the radiation direction determination unit 103 according to circuit information changed by the wiring information changing unit 102, it is possible to generate and output appropriate circuit information indicating that an influence of radiation noise on a communication circuit is small.

As described above, it is possible to suppress deterioration of communication performance in advance by determining a direction in which radiation noise is radiated for each of various wiring layouts of an integrated circuit, and by deriving an appropriate wiring layout in which an influence of radiation noise on a communication circuit is small.

### Second Exemplary Embodiment

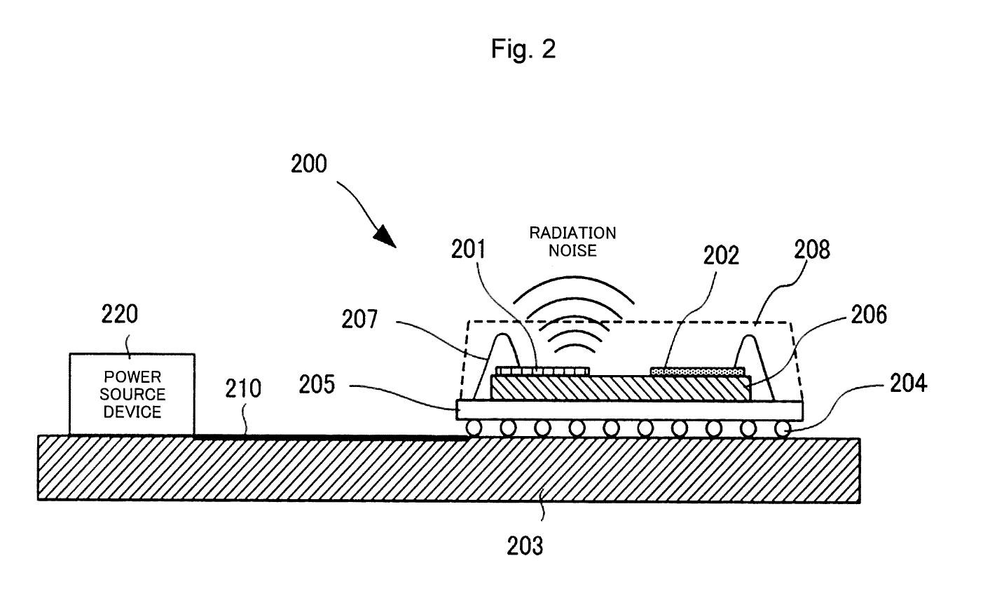

Next, an information processing device according to the second exemplary embodiment of the present invention is described using FIG. 2 to FIG. 12. FIG. 2 is a diagram for describing a schematic configuration of an integrated circuit, namely, an IC chip 200, to be designed by the information processing device in the exemplary embodiment.

A digital circuit 201 for processing logic data and an RF circuit 202 for processing a communication signal are mounted on the IC chip 200. Employing a structure that circuit blocks having different functions are mounted on one chip as described above is advantageous in miniaturizing and thinning the chip.

Specifically, a silicon substrate 206 is fixedly connected to a printed circuit board 203 via solder balls 204 and an interposer 205. Each of the circuits 201 and 202, and the interposer 205 are connected via a bonding wire 207. The surrounding of each of the circuits 201 and 202 is fixed by a resin mold 208. Further, a power source device 220 is connected on the printed circuit board 203. The power source device 220 and the digital circuit 201 are electrically connected to each other via the bonding wire 207, the interposer 205, the solder balls 204, and a substrate wiring 210.

In the IC chip 200 having the aforementioned configuration, the processing speed of the digital circuit 201 increases, as a demand for a high-speed operation and enhanced functionality increases, and high frequency electromagnetic noise occurs accompanied by an operation of the digital circuit 201. Such high frequency electromagnetic noise may be coupled to the RF circuit 202 via the space above the circuit. Then, the noise coupling may adversely affect communication signal processing, and may cause lowering of a communication speed or an erroneous operation of a device. In view of the aforementioned circumstances, the information processing device of the exemplary embodiment is configured to accurately estimate radiation noise at a stage of designing an integrated circuit, and to derive a circuit designing and a circuit layout capable of suppressing an adverse influence by the radiation noise.

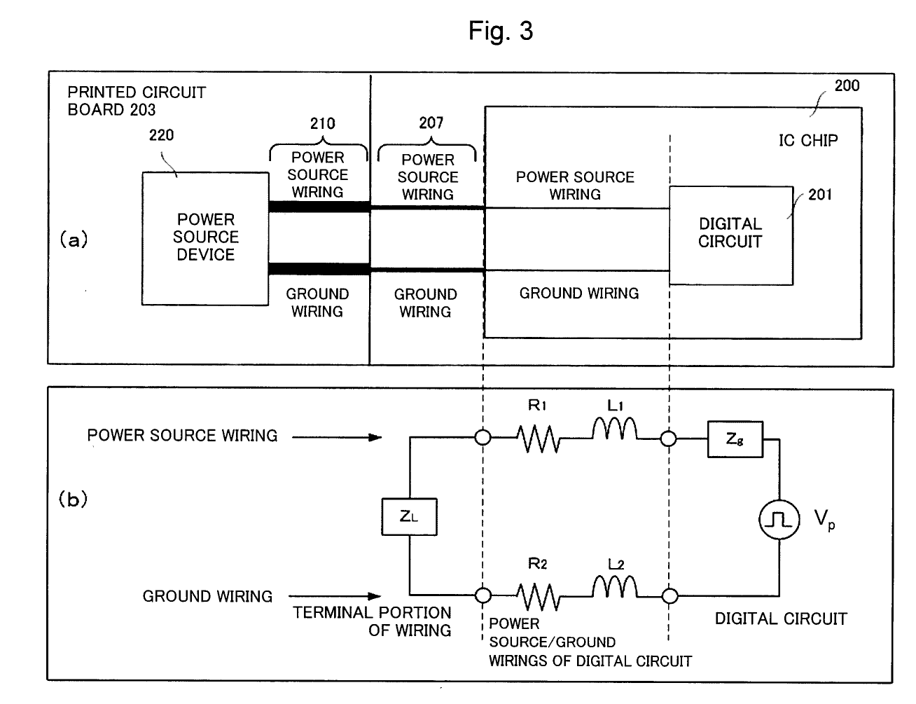

FIG. 3 illustrates a schematic view (a) of power source/ground wirings from the power source device 220 to the digital circuit 201 within the IC chip 200, and an equivalent circuit diagram (b) thereof. In the equivalent circuit diagram (b), Vₚ denotes a noise voltage generation source in the digital circuit 201, and Z_{g} denotes an internal impedance according to noise. Further, R₁ and L₁ respectively denote a resistance and an inductance of a power source wiring connected to the digital circuit 201 within the IC chip 200. R₂ and L₂ respectively denote a resistance and an inductance of a ground wiring connected to the digital circuit 201 within the IC chip 200. Z_{L} denotes a load impedance of a terminal portion of the power source/ground wirings of the digital circuit 201, and corresponds to an input impedance when the side of the power source device 220 is viewed from the side of the IC chip 200. Note that this example is described based on the premise that a circuit includes a pair of a power source wiring and a ground wiring. The invention of the present application, however, is not limited to the above. The present invention is also applicable to an IC chip including two or more pairs of power source wirings and ground wirings.

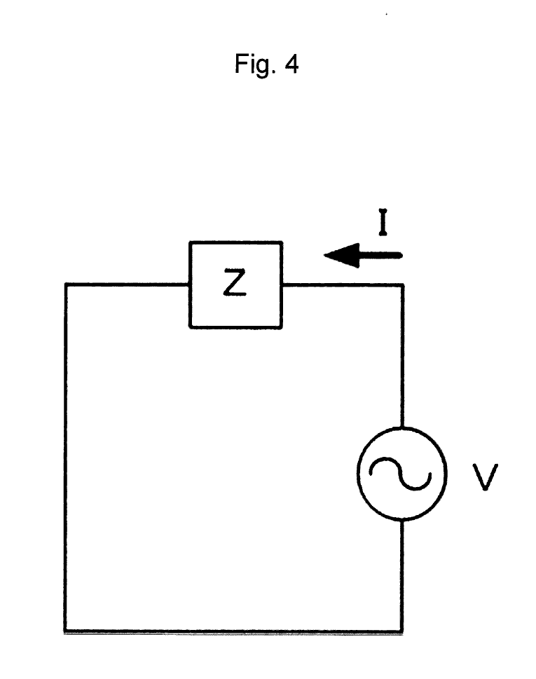

FIG. 4 is a diagram, in which power source/ground wirings of the digital circuit 201 are regarded as an electric/magnetic dipole Z as a noise radiation source, and the equivalent circuit in FIG. 3 is converted to an equivalent circuit of the dipole Z. In this example, Z is expressed by the following Eq. (1), and current I flowing through the dipole Z is obtained from Eq. (2) using a noise voltage V at a target frequency.

Z=Z_{g}+R₁+jωL₁+Z_{L}+R₂+jωL₂ Eq. (1)

I=V/Z Eq. (2)

It is possible to obtain a radiation electromagnetic field radiated from an electric/magnetic dipole on the basis of a value of the current I. Note that when Z_{L} is a value corresponding to an opened state, Z_{L} is equivalent to a radiation resistance in a wiring, and FIG. 4 illustrates an equivalent circuit of an electric dipole (electric dipole model). When Z_{L} is not a value corresponding to an opened state, FIG. 4 illustrates an equivalent circuit of a magnetic dipole (magnetic dipole model).

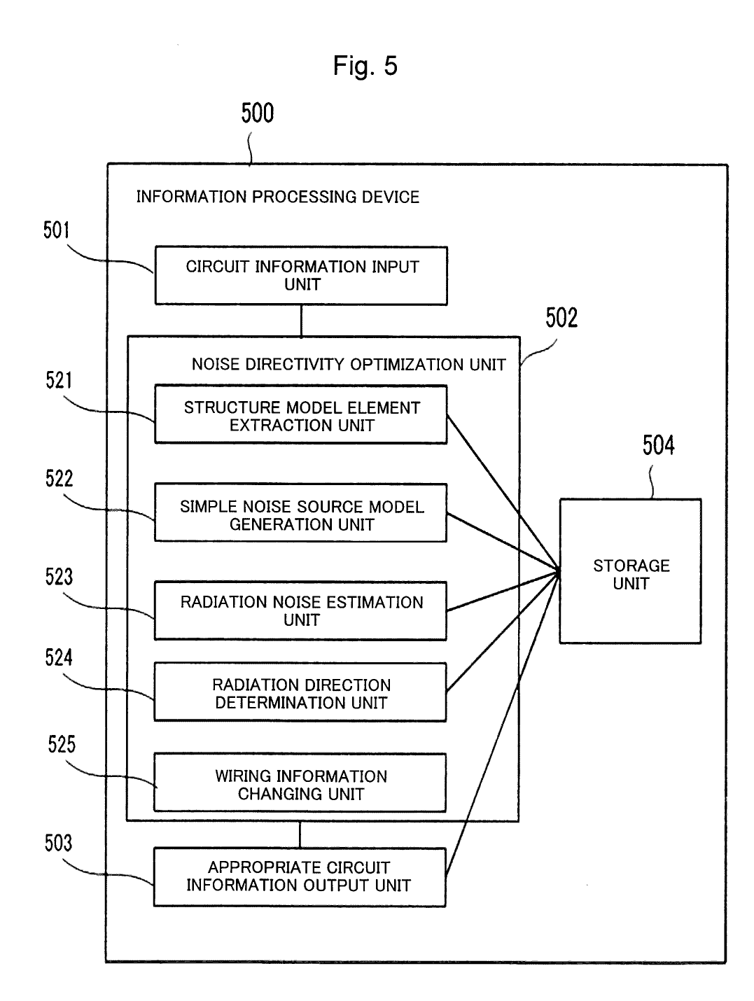

FIG. 5 is a functional configuration diagram of an information processing device 500 for use in design support, which is configured to prevent noise radiated from power source/ground wirings of a digital circuit from being directed toward an RF circuit, with use of a dipole as a radiation noise source model. The information processing device 500 includes a circuit information input unit 501, a noise directivity optimization unit 502, an appropriate circuit information output unit 503, and a storage unit 504. The noise directivity optimization unit 502 includes a structure model element extraction unit 521, a simple noise source model generation unit 522, a radiation noise estimation unit 523, a radiation direction determination unit 524, and a wiring information changing unit 525.

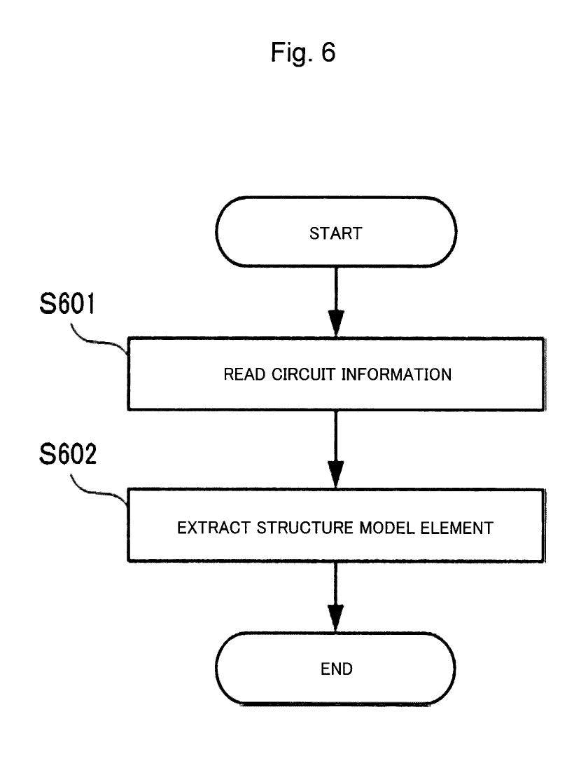

FIG. 6 is a flowchart illustrating an operation of the structure model element extraction unit 521. As illustrated in FIG. 6, the structure model element extraction unit 521 acquires, from the circuit information input unit 501, wiring layout information (e.g. information indicating a wiring length) on the inside and the periphery of the IC chip 200 in Step S601. Next, in Step S602, the structure model element extraction unit 521 extracts a structure model element on the basis of the acquired wiring layout information. The structure model element includes a size of a silicon substrate, a dielectric constant of the silicon substrate, the number of pairs of power source/ground wirings to be connected to a digital circuit, and wiring lengths of the power source/ground wiring pairs.

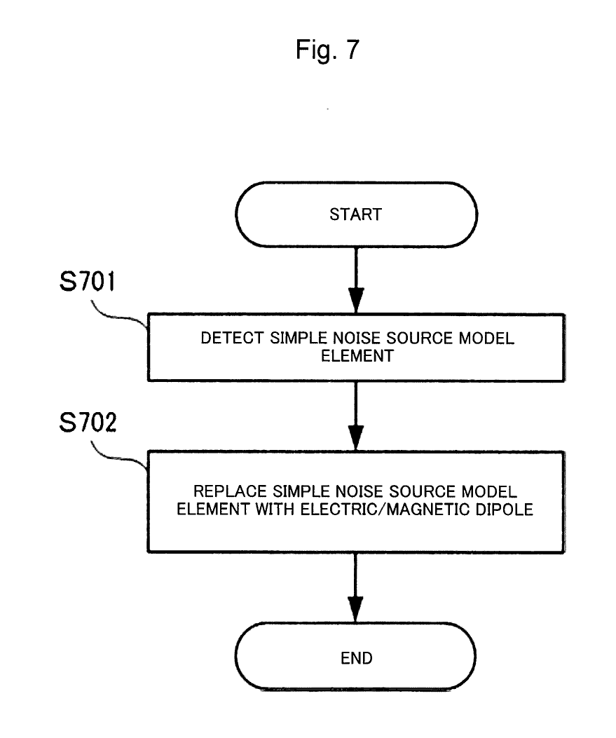

FIG. 7 is a flowchart illustrating an operation of the simple noise source model generation unit 522. The simple noise source model generation unit 522 performs noise source modeling (extraction of a simple noise source model element) with respect to each pair of power source/ground wirings on the basis of a structure model element, which is data extracted by the structure model element extraction unit 521 in response to reading of circuit information in Step S701. The simple noise source model element includes an operation timing of a digital circuit, an internal impedance of a power source system in the digital circuit, an impedance of power source/ground wirings, and a load impedance of the power source/ground wirings. Thereafter, the simple noise source model generation unit 522 replaces the simple noise source model element with an electric/magnetic dipole in Step S702.

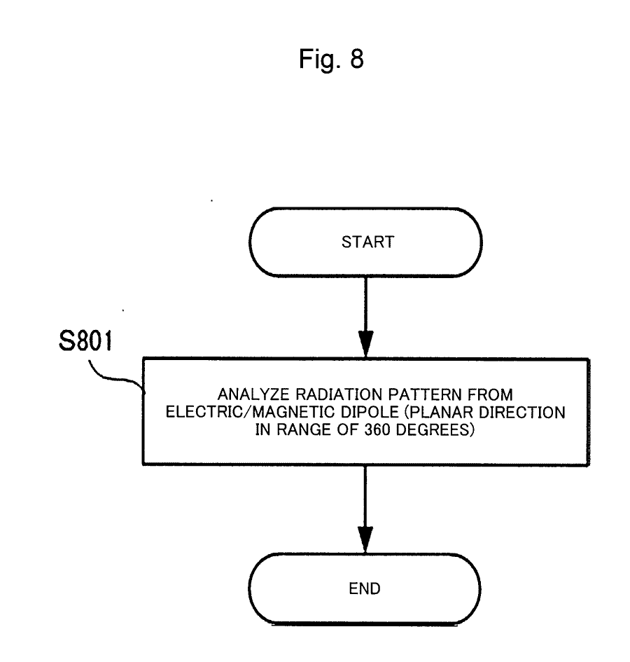

FIG. 8 is a flowchart illustrating an operation of the radiation noise estimation unit 523. The radiation noise estimation unit 523 performs pattern analysis of radiation noise radiated from an electric/magnetic dipole as a noise source model in a planar direction in the range of 360 degrees, as illustrated in Step S801, with use of the electric/magnetic dipole generated by the simple noise source model generation unit 522.

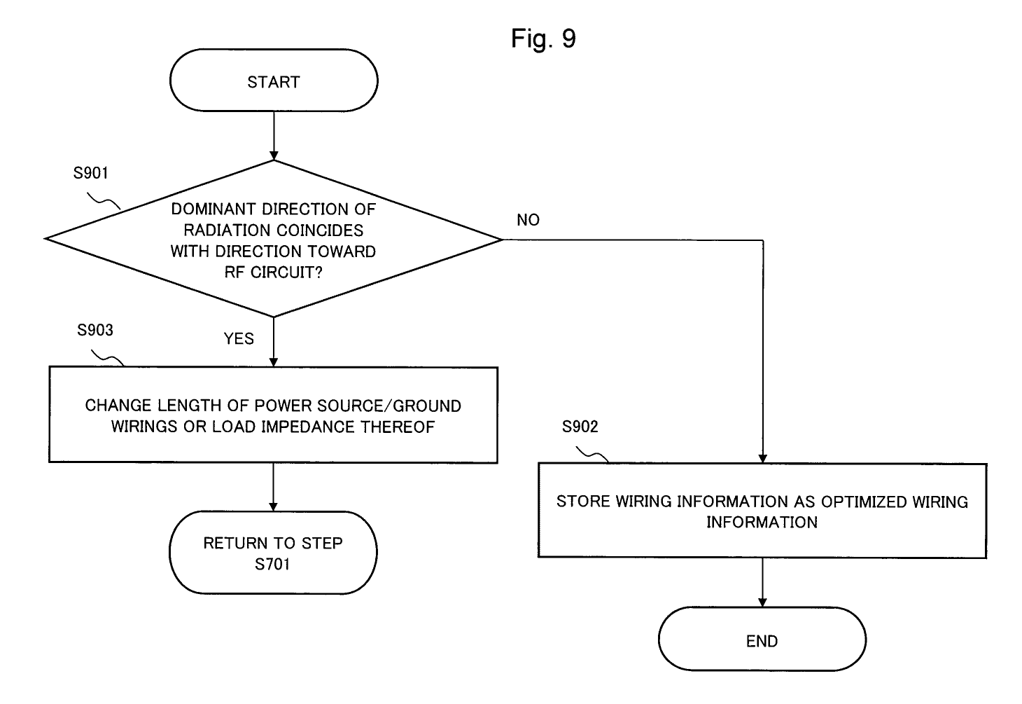

FIG. 9 is a flowchart illustrating an operation of the radiation direction determination unit 524 and the wiring information changing unit 525. In Step S901, the radiation direction determination unit 524 determines whether or not a dominant direction of radiation noise (e.g. a direction in which radiation noise is most strongly radiated) coincides with a direction toward the RF circuit 202, as a result of analysis by the radiation noise estimation unit 523. When the dominant direction of radiation noise does not coincide with a direction toward the RF circuit 202, the routine proceeds to Step S902, in which circuit information in this state is stored in the storage unit 504, and the process is terminated. On the other hand, when the dominant direction of radiation noise coincides with a direction toward the RF circuit 202, the routine proceeds to Step S903, in which the length of power source/ground wirings, or the load impedance of the power source/ground wirings in the circuit information is changed. Then, the changed element data is input to the simple noise source model generation unit 522, and the routine is returned to the process of Step S701 to execute generation of a simple noise source model. Then, the aforementioned operation is repeated until the dominant direction of radiation does not coincide with a direction toward the RF circuit 202. The appropriate circuit information output unit 503 reads, from the data stored in the storage unit 504 as circuit information by the radiation direction determination unit 524, a wiring layout (circuit information) whose interference level with respect to the RF circuit 202 is low, and outputs the read circuit information as design data on power source/ground wirings of the digital circuit 201.

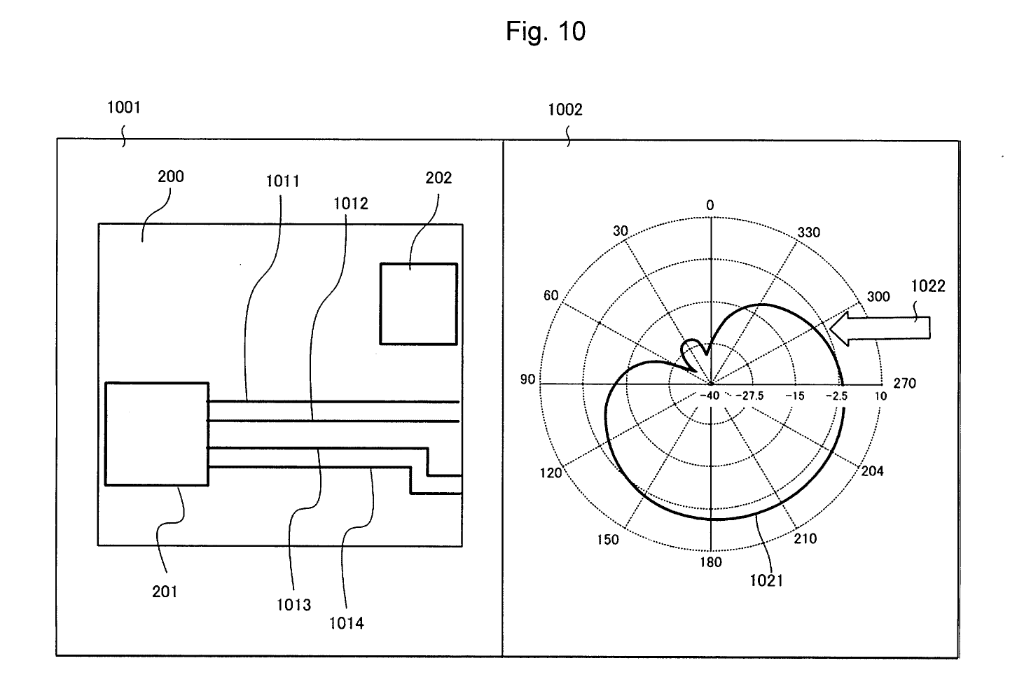

FIG. 10 is an explanatory diagram including a schematic plan view 1001 of an IC chip 200 on which a digital circuit and an RF circuit are mounted, and a radiation pattern schematic diagram 1002 analyzed by the radiation noise estimation unit 523 in the information processing device 500. In this example, in the schematic plan view 1001, there exist two pairs of power source/ground wirings 1011 to 1014 to be connected to a digital circuit 201 (two pairs: a pair constituted by 1011 and 1012, and a pair constituted by 1013 and 1014). The wiring lengths of the pairs are different from each other. Further, an RF circuit 202 is disposed in the upper right direction of the digital circuit 201 on the IC chip 200 illustrated in FIG. 10. Referring to the radiation pattern schematic diagram 1002, it is clear that noise radiation 1021 is relatively strongly radiated in a direction 1022 toward the RF circuit 202. In other words, in the wiring illustrated in the schematic plan view 1001, radiation noise may be coupled to the RF circuit 202. In this case, the wiring information changing unit 525 changes the length of power source/ground wirings, or the load impedance of the power source/ground wirings.

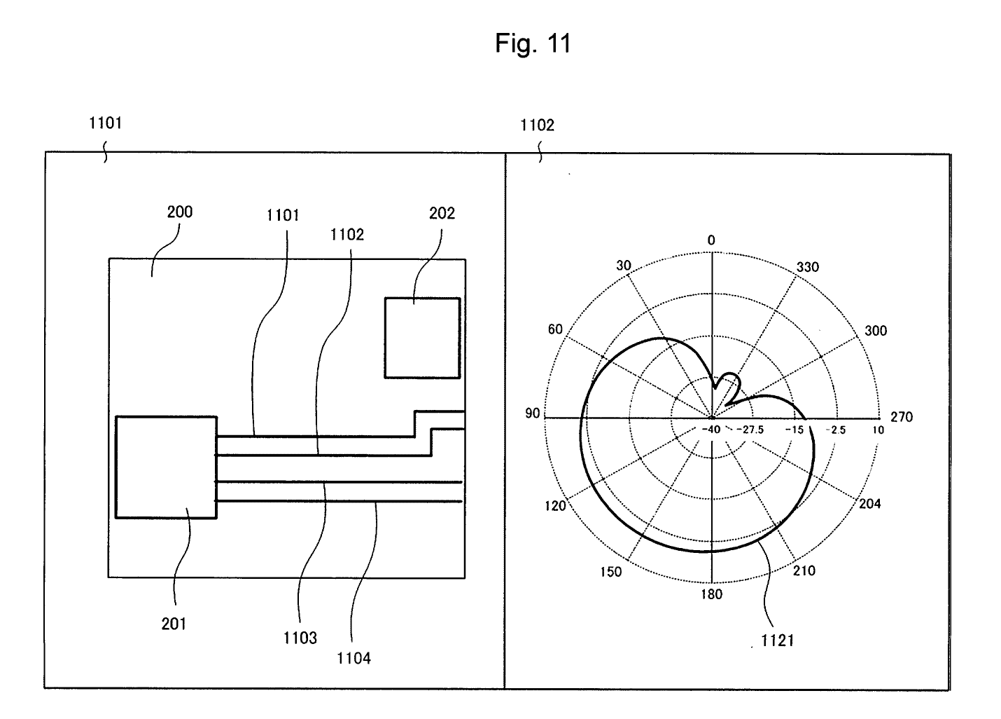

FIG. 11 is an explanatory diagram including a schematic plan view 1101 of an IC chip 200 on which a digital circuit, whose lengths of power source/ground wirings 1101 to 1104 are changed with respect to the wiring layout exemplified in FIG. 10, and an RF circuit are mounted, and a radiation pattern schematic diagram 1102. The radiation pattern schematic diagram 1102 illustrates a result reanalyzed by the radiation noise estimation unit 523 with respect to the IC chip 200 in which the lengths of power source/ground wirings are changed. Referring to the radiation pattern schematic diagram 1102, it is clear that noise radiation 1121 toward the RF circuit 202 is weak. Therefore, the radiation direction determination unit 524 determines that the radiation direction is a direction opposite to the direction toward the RF circuit, and the appropriate circuit information output unit 503 judges that the wiring layout in this case is an intended layout.

FIG. 10 and FIG. 11 exemplify that the ratio of wiring length between two pairs of power source/ground wirings is changed to change the direction of radiation noise. The present invention, however, is not limited to the above. For instance, when there are three pairs A, B, and C of power source/ground wirings on the IC chip 200, it is possible to estimate a radiation pattern as a whole by modeling each of the wiring pairs into a dipole, and by superimposing (summing) radiation patterns by the dipoles. Then, by changing the ratio LA:LB:LC of wiring length between the three pairs A, B, and C of power source/ground wirings in various ways, it is possible to change the amount (e.g. the intensity) and the directivity of radiation noise.

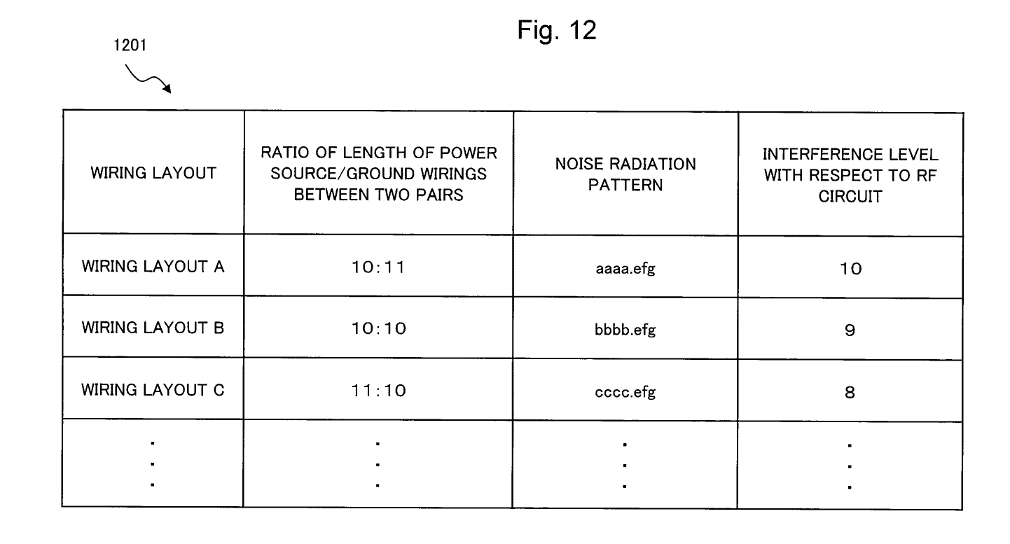

FIG. 12 is a diagram illustrating a degree of appropriateness (interference level with respect to an RF circuit) for each wiring layout stored in the storage unit 504. As illustrated in FIG. 12, by estimating a noise radiation pattern, and storing an interference level with respect to an RF circuit for comparison for each of the wiring layouts, it is possible to derive a more appropriate wiring pattern.

In the exemplary embodiment, as described above, the radiation direction determination unit 524 changes the length of power source/ground wirings, and the appropriate circuit information output unit 503 outputs design data on power source/ground wirings of a digital circuit. However, the present invention is not limited to a configuration, in which the length of power source/ground wirings is changed for re-determination when the radiation direction determination unit 524 determines that there is noise radiation toward an RF circuit. For instance, a load impedance of the IC chip 200 may be changed. Changing a load impedance also makes it possible to change a radiation pattern. Therefore, when it is difficult to change the length of power source/ground wirings, a load impedance may be changed, and the appropriate circuit information output unit 503 may output design data on power source/ground wirings.

By applying the information processing device 500 of the exemplary embodiment, it is possible to control the direction of noise radiated into the space from power source/ground wirings of a digital circuit in an IC on which the digital circuit and an RF circuit are mounted. As a result, it is possible to provide an IC capable of suppressing coupling of radiation noise to an RF circuit. Further, by mounting the IC on a printed circuit board, and manufacturing a wireless device, it is possible to provide a device in which deterioration of communication quality by noise coupling does not occur.

In the exemplary embodiment, the information processing device 500 generates an equivalent circuit including a noise generation source in a digital circuit, an internal impedance which may affect noise, power source/ground wirings to be connected to the digital circuit, and a load impedance of the power source/ground wirings in an IC on which the digital circuit and an RF circuit are mounted. Then, a noise radiation source model is expressed by an electric dipole or a magnetic dipole, which is equivalent to the noise radiation source model. Further, a noise radiation pattern is generated with use of an equivalent model, while changing at least one of the length of power source/ground wirings, and the value of impedance added to the power source/ground wirings in various ways for obtaining the length of power source/ground wirings, at which noise radiated from a digital circuit into the space is not directed toward an RF circuit.

In other words, it is possible to design a circuit layout, in which noise is not coupled to an RF circuit via the space above a circuit after radiation noise which may be generated from power source/ground wirings of a digital circuit is estimated. Namely, it is possible to suppress deterioration of communication performance in a circuit in advance.

### Other Exemplary Embodiments

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims. Further, a system or a device obtained by combining the individual features included in each of the exemplary embodiments in any way is included in the category of the present invention.

Further, the present invention may be applied to a system constituted by a plurality of devices, or may be applied to a single device. Furthermore, the present invention is also applicable to a configuration, in which an information processing program for implementing the functions of the exemplary embodiments is directly or remotely supplied to a system or to a device. Therefore, a program to be installed in a computer so as to implement the functions of the present invention by the computer, a signal including the program, a medium storing the program, and a World Wide Web (WWW) server which causes the computer to download the program are included in the category of the present invention. In particular, at least a non-transitory computer readable medium storing a program which causes a computer to execute the processing steps included in the exemplary embodiments is included in the category of the present invention.

### Other Expression on Exemplary Embodiments

The whole or part of the exemplary embodiments disclosed above can be described as, but not limited to, the following supplementary notes.

(Supplementary Note 1)

An information processing device comprising:

a noise estimation means which estimates radiation noise radiated from an information processing circuit on the basis of a wiring layout of the information processing circuit;

a wiring information changing means which changes circuit information for determining the wiring layout of the information processing circuit;

a radiation direction determination means which determines whether or not radiation noise radiated from the information processing circuit is radiated in a direction in which an influence on a communication circuit in proximity to the information processing circuit is small; and

an appropriate circuit information output means which generates and outputs appropriate circuit information indicating that an influence of radiation noise on the communication circuit is small by repeating the noise estimation process by the noise estimation means and the determination by the radiation direction determination means according to the circuit information changed by the wiring information changing means.

(Supplementary Note 2)

The information processing device according to supplementary note 1, wherein

the appropriate circuit information is output by estimating radiation noise in an integrated circuit configured such that the information processing circuit and the communication circuit are mounted on one chip.

(Supplementary Note 3)

The information processing device according to supplementary note 1 or 2, wherein

the noise estimation means includes:

a structure model element extraction means which extracts an element of a structure model of the integrated circuit;

a noise source model generation means which models power source/ground wirings of the information processing circuit into a noise source model; and

an unnecessary radiation analysis means which analyzes radiation noise radiated from the noise source model in a planar direction in a range of 360 degrees.

(Supplementary Note 4)

The information processing device according to supplementary note 3, wherein

the structure model element to be extracted by the structure model element extraction means includes at least one of a size of a silicon substrate, a dielectric constant of the silicon substrate, the number of pairs of power source and ground wirings to be connected to the information processing circuit, and wiring lengths of the power source and ground wiring pairs.

(Supplementary Note 5)

The information processing device according to supplementary note 3 or 4, wherein

the noise source model generation means generates an electric dipole model or a magnetic dipole model from at least one of the elements constituted by an operation timing of the information processing circuit, an internal impedance of a power source system in the information processing circuit, an impedance of the power source/ground wirings of the information processing circuit, and a load impedance of the information processing circuit in modeling the power source/ground wirings of the information processing circuit into the noise source model.

(Supplementary Note 6)

The information processing device according to any one of supplementary notes 1 to 5, wherein

the wiring information changing means changes a length of power source/ground wirings of the information processing circuit, or a load impedance of the information processing circuit when a dominant direction of the radiation noise coincides with a direction toward the communication circuit.

(Supplementary Note 7)

An information processing method including:

a noise estimation step of estimating radiation noise radiated from an information processing circuit on the basis of a wiring layout of the information processing circuit;

a wiring information changing step of changing circuit information for determining the wiring layout of the information processing circuit;

a radiation direction determination step of determining whether or not radiation noise radiated from the information processing circuit is radiated in a direction in which an influence on a communication circuit in proximity to the information processing circuit is small; and

an appropriate circuit information output step of generating and outputting appropriate circuit information indicating radiation of radiation noise in a direction in which an influence on the communication circuit in proximity to the information processing circuit is small by repeating the noise estimation process by the noise estimation step and the determination by the radiation direction determination step according to the circuit information changed by the wiring information changing step.

(Supplementary Note 8)

An information processing program which causes a computer to execute:

a noise estimation step of estimating radiation noise radiated from an information processing circuit on the basis of a wiring layout of the information processing circuit;

a wiring information changing step of changing circuit information for determining the wiring layout of the information processing circuit;

a radiation direction determination step of determining whether or not radiation noise radiated from the information processing circuit is radiated in a direction in which an influence on a communication circuit in proximity to the information processing circuit is small; and

an appropriate circuit information output step of generating and outputting appropriate circuit information indicating radiation of radiation noise in a direction in which an influence on the communication circuit in proximity to the information processing circuit is small by repeating the noise estimation process by the noise estimation step and the determination by the radiation direction determination step according to the circuit information changed by the wiring information changing step.

This application is based upon and claims the benefit of priority from Japanese patent application No. 2014-040294, filed on Mar. 3, 2014, the disclosure of which is incorporated herein in its entirety by reference.

1. An information processing device comprising:
a noise estimation unit which estimates radiation noise radiated from an information processing circuit on the basis of a wiring layout of the information processing circuit;
a wiring information changing unit which changes circuit information for determining the wiring layout of the information processing circuit;
a radiation direction determination unit which determines whether or not radiation noise radiated from the information processing circuit is radiated in a direction in which an influence on a communication circuit in proximity to the information processing circuit is small; and
an appropriate circuit information output unit which generates and outputs appropriate circuit information indicating that an influence of radiation noise on the communication circuit is small by repeating the noise estimation process by the noise estimation unit and the determination by the radiation direction determination unit according to the circuit information changed by the wiring information changing unit.

2. The information processing device according to claim 1, wherein
the appropriate circuit information is output by estimating radiation noise in an integrated circuit configured such that the information processing circuit and the communication circuit are mounted on one chip.

3. The information processing device according to claim 3, wherein
the noise estimation unit includes:
a structure model element extraction unit which extracts an element of a structure model of the information processing circuit; and
a noise source model generation unit which models power source/ground wirings of the information processing circuit into a noise source model, wherein
radiation noise radiated from the noise source model is analyzed in a planar direction in a range of 360 degrees.

4. The information processing device according to claim 3, wherein the structure model element to be extracted by the structure model element extraction unit includes at least one of a size of a silicon substrate, a dielectric constant of the silicon substrate, the number of pairs of power source and ground wirings to be connected to the information processing circuit, and wiring lengths of the power source and ground wiring pairs.

5. The information processing device according to claim 3, wherein
the noise source model generation unit generates an electric dipole model or a magnetic dipole model from at least one of the elements constituted by an operation timing of the information processing circuit, an internal impedance of a power source system in the information processing circuit, an impedance of the power source/ground wirings of the information processing circuit, and a load impedance of the information processing circuit in modeling the power source/ground wirings of the information processing circuit into the noise source model.

6. The information processing device according to claim 1, wherein
the wiring information changing unit changes a length of power source/ground wirings of the information processing circuit, or a load impedance of the information processing circuit when a dominant direction of the radiation noise coincides with a direction toward the communication circuit.

7. An information processing method comprising:
estimating radiation noise radiated from an information processing circuit on the basis of a wiring layout of the information processing circuit;
changing circuit information for determining the wiring layout of the information processing circuit;
determining whether or not radiation noise radiated from the information processing circuit is radiated in a direction in which an influence on a communication circuit in proximity to the information processing circuit is small; and
generating and outputting appropriate circuit information indicating radiation of radiation noise in a direction in which an influence on the communication circuit in proximity to the information processing circuit is small by repeating the estimation of radiation noise and the determination according to the changed circuit information.

8. A storage medium storing an information processing program which causes a computer to execute processes of:
estimating radiation noise radiated from an information processing circuit on the basis of a wiring layout of the information processing circuit;
changing circuit information for determining the wiring layout of the information processing circuit;
determining whether or not radiation noise radiated from the information processing circuit is radiated in a direction in which an influence on a communication circuit in proximity to the information processing circuit is small; and
generating and outputting appropriate circuit information indicating radiation of radiation noise in a direction in which an influence on the communication circuit in proximity to the information processing circuit is small by repeating the estimation of radiation noise and the determination according to the changed circuit information.
